(19) United States
(12) Patent Application Publication
(10) Pub. No.: US 2014/0365240 A1
(43) Pub. Date: Dec. 11, 2014

(54) SYSTEM AND METHOD FOR CROSS-PLATFORM SENTIMENT AND GEOGRAPHIC-BASED TRANSACTIONAL SERVICE SELECTION

(71) Applicant: James Canton, Mill Valley, CA (US)

(72) Inventor: James Canton, Mill Valley, CA (US)

(21) Appl. No.: 13/912,009

(22) Filed: Jun. 6, 2013

(51) Int. Cl. G06Q 50/22; G06F 19/00; G06Q 30/02

(52) U.S. Cl. CPC G06Q 50/22; G06Q 30/0201; G06F 19/3456
USPC 705/3; 705/7.29; 705/2

(57) ABSTRACT

In one exemplary embodiment, a method of a telehealth services system includes the step of providing a healthcare providers database. The healthcare providers database includes an healthcare provider schedule information, a healthcare provider specialty information and a healthcare provider pricing information. The method includes the step of providing a search engine. The search engine is configured to search the database of healthcare providers based on at least one keyword. The method includes the step of providing a scheduling module configured to schedule an appointment between a consumer and a healthcare provider. A negotiation module is provided to mediate a price negotiation between the consumer and the healthcare provider.

### CROSS-REFERENCE TO RELATED APPLICATIONS

This application claims the benefit of U.S. Provisional Application No. 61/656,367, filed Jun. 6, 2012 and titled ‘SYSTEM AND METHOD FOR CROSS-PLATFORM SENTIMENT AND GEOGRAPHIC-BASED TRANSACTIONAL SERVICE SELECTION’. This provisional applications is incorporated herein by reference.

### BACKGROUND

1. Field

This application relates generally to computerized transactional services offered over the Internet and mobile networks, and more specifically to a system, article of manufacture and method for cross-platform sentiment and geographic-based transactional service selection that connects buyers and sellers of commercial services.

2. Related Art

Transactional services can allow users to perform transactions such as purchasing goods or services, searching for information, insurance or personal services, such as medical services using networks such as the Internet. Software can be used to facilitate the use of transactional services and to match sellers with buyers in an effective manner. It is desired to have an improved system to match buyers and sellers with an appropriate transactional service.

### BRIEF SUMMARY OF THE INVENTION

In one aspect, a system includes a number of transactional services. The system also includes a client. The client is one of a telematic client, an interactive TV-based client, a mobile client, a computer-based client, a telephone client, a game platform client, a sensor-based client or a wearable/embedded client. A discovery unit receives input from the client. The discovery unit determines a sentiment-based fit of one or more of the transaction services for a user at the client. The discovery unit uses one or more of geospatial location, geospatial information, geo-mapping, data analysis, predictive analysis, near field communications data, interactive voice response analysis, short code data analysis texting analysis or neuro-marketing information to make the sentiment-based fit to optimize the transaction between the seller and the buyer of services.

In another aspect, a method of a telehealth services system includes the step of providing a healthcare providers database. The healthcare providers database includes an healthcare provider schedule information, location, availability, a healthcare provider specialty information and a healthcare provider pricing information. The method includes the step of providing a search engine. The search engine is configured to search the database of healthcare providers based on at least one keyword. The method includes the step of providing a scheduling module configured to schedule an appointment between a consumer and a healthcare provider. A negotiation module is provided to mediate a price negotiation between the consumer and the healthcare provider.

### BRIEF DESCRIPTION OF THE DRAWINGS

The present application can be best understood by reference to the following description taken in conjunction with the accompanying figures, in which like parts may be referred to by like numerals.

FIG. 1 shows a number of transactional services, according to some embodiments.

FIG. 2 shows an alternate embodiment of number of transactional services, according to some embodiments.

FIG. 3 illustrates a sample computing environment which can be utilized in some embodiments.

FIG. 4 depicts computing system with a number of components that may be used to perform the above-described processes.

FIGS. 5 A-B illustrate an example process of a telehealth services system, according to some embodiments.

The Figures described above are a representative set, and are not an exhaustive with respect to embodying the invention.

### DETAILED DESCRIPTION

Disclosed are a system, method, and article of manufacture for cross-platform sentiment and geographic-based transactional service selection. The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Environment and Architecture

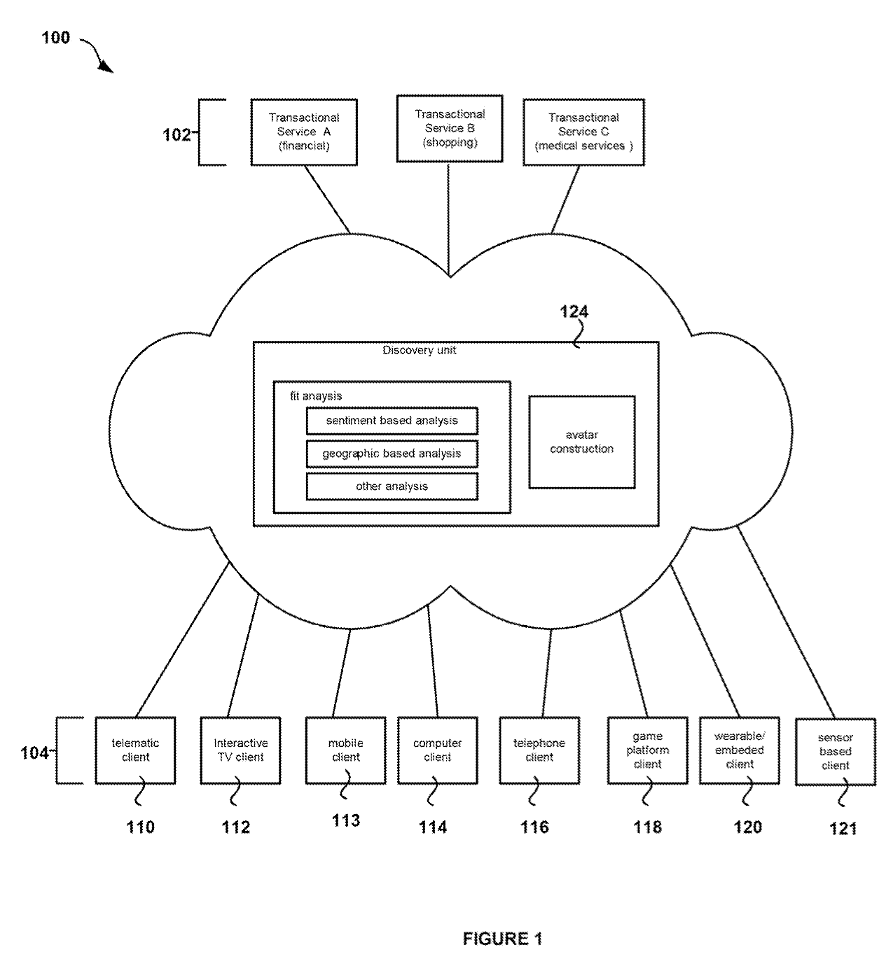

FIG. 1 shows a number of transactional services 102, according to some embodiments. These transactional services 102 can include retail sites, personal services sites, insurance, health care transactional services, electronic commerce, or any other good or service that is bought or sold.

A client 104 can include one of a telematic client 110 (software that interacts with autos and transportation systems over mobile and satellite networks), an interactive TV-based client 112, a mobile client 113, a computer-based client 114, a telephonic client 116, a game platform client 118, a wearable/embedded client 120 and a sensor based client 121 (such as a embedded microchip and/or device). Telematic client 110 can be a computing device that include functionalities for the integrated use of telecommunications and informatics (e.g. for application in vehicles and with control of vehicles on the move). Telematics can include, but is not limited to, Global Positioning System (GPS) technology integrated with computers and mobile communications technology in automotive navigation and/or other control/tracking systems. Interactive TV-based client 112 can include any form of media convergence technologies (e.g. adding data services to traditional television technology). Mobile clients 113 can operate in various mobile devices (e.g. smartphones, tablet computers, etc.). In some examples, a mobile device can include integrated data capture devices such as barcode, RFID and/or smart card readers. Computer-based client 114 can operate in a computing system (e.g. a laptop computer, a personal computer, an enterprise-level computing system, a wearable device, a robotic assistant virtual or physical in form, etc.). Telephonic client 116 can operate in various telecommunication services for the purpose of electronic transmission of voice, fax, or data, between distant parties. Game platform client 118 can operate in a video-game platform (e.g. the combination of electronic components and/or computer hardware which, in conjunction with software, allows a video game to operate). A wearable/embedded client 120 can operate in a wearable/body-borne computer (e.g. Google Glass®, heart-rate monitors, various smart-wearable systems, and the like). As used herein, a wearable/body-borne computer can include miniature electronic devices that are worn by the bearer under, with or on top of clothing. Wearable/body-borne computer can include various biosensors and/or environmental sensors, as well as computer networking interfaces. A sensor-based client 121 can include a functionality coupled with a sensor. Sensor-based client can include computer networking system(s) for communicating sensor data with a remote computer system over the Internet or mobile networks.

A discovery unit 124 receives inputs from one of the client(s) 104. The discovery unit 124 determines a fit of one or more of the transaction services for a user at the client 104. The discovery unit 124 can then provide suggestions or advertising based on this fit.

The discovery unit 124 can be cloud-based to allow for client data and applications to be stored in the network. This allows for the clients to be lightweight and for the applications, such as the discovery unit 124, to scale up quickly to additional users and otherwise adjust resources to unpredictable business demands. The cloud architecture can be private, public, or a hybrid.

The discovery unit 124 can make a sentiment-based fit of which of the one or more transaction services are most useful or desirable for the user. A sentiment-based fit is the determination of a fit based on the identification of subjective information from source material associated with a user. This source material is analyzed to extract attitudes, judgments or emotions with respect to certain topics that are opinion minded by sentiment analysis of keyword, concept, context or other semantic analytics accessed by the system: including the sentiment analysis of social media access by the system.

The sentiment analysis is determined by evaluating attitudes which can be simple polarity judgments indicating positive, neutral or negative opinions. The determined attitudes can also be more precise determinations of associated emotions like happiness, indifference, disinterest, disgust, fear and anger. These determined attitudes can also be associated with an intensity value. For example, a range of intensity values can be set in an index and matched with various inputs from client 104 (e.g. with a hash function).

In one embodiment, the sentiment-based fit can be done by checking sentiments with respect to topics that are associated with certain transaction services. For example, positive sentiment with respect to the topic of “shoes” may make a site that sells shoes a good fit. In another embodiment, sentiment/topic pairs can be analyzed, by themselves or along with additional data to determine a fit. For example, historical data of transaction service use by previous users along with these previous users' extracted sentiment/topic pairs, by themselves or along with additional data, can be used as a training set to determine correlations between the sentiment/topic pairs and use of the transaction service.

Sentiment analysis can include a semantic analysis to use language to determine preferences and personalization. Such a semantic analysis can be dynamically captured and analyzed over electronic networks. In one embodiment, sentiment analytics, neuroscience and semantic analysis are combined over mobile and electronic networks for electronic commerce and/or transaction service fit determination. The integration of these analytic parts that make up the sentiment analysis contributes to the sentiment operational framework that provides meaning and fitness for matching preferences (products, services, solutions, certain knowledge products etc.) by the buyer with resources offered by the seller.

In one embodiment, the discovery unit 124 can make a sentiment- and geographic-based fit. Extracted sentiment and geographic data can be used to determine a fit between the user and a transaction service. The geographic information can include geospatial location, geospatial information, and geomapping information. For example, a user's location can be used help make the fit with the transaction service. People in certain locations can have a greater or lesser affinity for certain transaction services; and this can be reflected by the determined fit. Certain locations can be used to produce adjusted sentiment values or sentiment/topic pairs. Alternately, the historical training data can be restricted or weighted based on location.

In one embodiment, the discovery unit 124 can also use one, two or three or more of geospatial location; geospatial information, geomapping, data analysis, predictive analysis, near field communications data, interactive voice response analysis, short code data, and neuro-marketing information to make the sentiment-based fit.

Data analysis can include inspecting, cleaning, transforming, and modeling data by data mining, business, exploratory data analysis (EDA), confirmatory data analysis (CDA), text analytics and data modeling. Predictive analysis can use statistical modeling to analyze existing data to make predictions about future events.

Near field communications allow for Smartphone's to communicate with one another by touch or close physical proximity. Near field communications are used for purchases and data exchanges. Analysis of near field communication data can be used to determine personal networks and/or other information that can be used to improve a fit determination with respect to transactional services.

Interactive voice response (IVR) systems allow computers to interact with users through voice analysis. Interactive voice response data can be used to improve a fit determination with respect to transactional services.

Neuro-marketing is research that studies consumers' neurological response to marketing stimuli and products. Tools like functional magnetic resonance imaging (fMRI), electroencephalography (EEG) steady state topography (SST) and other sensors can be used to measure biometric information to learn how consumers make decisions they do, and what part of the brain is telling them to make such decisions. Such neuro-marketing information can be obtained from a user or other information can be used to match a user with a neurological profile.

Short codes are special telephone numbers shorter than full telephone numbers that are used to address text messages. Short codes are used for television program voting, ordering ringtones, charity donations and mobile services. Automatic programs handle responses to short code texts by responding to command words or prefixes. Short code data can be analyzed to determine the fit with a transactional service. For example, the use of certain short codes can indicate that a user is a good or bad fit for a specific transactional service.

The source material for the sentiment-based analysis can include material associated with a user. For example source material obtained from social media, such as blogs and social networks. The source material can also include short codes and/or near field communications data or any other data associated with a user.

In one embodiment, the discovery software 124 can use at least two (or at least three) of geospatial location, geospatial information, geomapping, data analysis, predictive analysis, near field communications data, interactive voice response analysis, and neuro-marketing information to make a sentiment-based fit.

The discovery unit 124 can use an agent or avatar, such as a personal agent or avatar. The personal avatar can be configurable with input from a user or by using sentiment, geographic or other information about a user. This avatar can guide the user through the selection of a transaction service. The avatar can provide customer service, confirm identity, conduct financial transactions, geo-locate information, shop, conduct commerce, compare product features, provide shipping, offer advice, conduct analytics, communicate to users and other agents across networks via voice, email, video and text over mobile networks, satellite, television, telecom and the Internet. In one example, other analysis can include predictive analytics functionalities such as those provided infra.

The avatar can be a software user interface that communicates, searches, transacts, locates services for users of electronic commerce and services over electronic networks. An expert system can be used to organize data, advise, recommend, analyze user interests and information and retrieve info on demand for users over electronic networks and for transacting electronic commerce.

An avatar can be downloaded as a software application, to electronic network devices (wearable, embedded or bio-implantable in humans), habitats, autos, robotics, virtual and physical domains such as television or Web channels to provide customized transportable services and transactions for users, such as commerce, analysis, health monitoring, disease management, energy management, training, security and situational awareness.

Avatar software can provide full range of social media, voice, video, text messaging and data communications capabilities to interact with humans, other avatars, robotics, electronic networks, e commerce and shopping enterprises online and off.

Avatar software can perform advisory services over electronic networks for humans including storage of data, compare value metrics, retrieve from memory, transact electronic commerce and communicate with humans, systems and products, services available online and offline.

Avatar software can provide mobile predictive sentiment analytics for both users and merchants of electronic commerce. Avatar form and features such as hair, skin color and voice and personality may by the use of software over mobile networks and the Internet be customized by users using licensed media personalities or generic design to match their preferences.

Avatars can provide a user interface to geolocate data, video, media, text, information or a genomic database. Avatars can provide sentiment and predictive analytics on the data and content of databases and have the capacity to interact and communicate.

A genomic database-based system can be used to include the use of synthetic biology and neuroscience related data science to formulate encryption software and for the security and protection of databases. A coded system using a computational biological framework can help secure the database and protecting data and privacy. As used herein, synthetic biology can include the design and construction of biological devices and systems for useful purposes. synthetic biology can combine biology and engineering, thus often overlapping with bioengineering and biomedical engineering. Synthetic biology can encompass a variety of different approaches, methodologies, and disciplines with a focus on engineering biology and biotechnology. Key technologies that can be utilized include, inter alia: DNA sequencing (e.g. determining the order of the nucleotide bases in a molecule of DNA); gene synthesis (creating artificial genes); modeling (e.g. with predict systems to predict behavior prior to fabrication); and quantitative measurements of relevant biological systems.

An alternate embodiment of the present invention is a system 200 for determining geographic data for users. A geo-locating component 210 can automatically geo-locate users and can produce geographic data for a user. The automatic geo-location can be done by analyzing data associated with the user.

A connection component, such as fit analysis unit 212, can use the geographic data to connect the user with sellers of goods or services. For example, the extracted geographic information can be used to suggest nearby service providers. The geographic information can also be used as part of a sentiment-based fit determination as discussed above.

The connection component, such as fit analysis unit 212, can connect the user to transact health, loans, or other services 202. Intelligent agents can be used to transact at least some services over an Internet, television, satellite or a mobile platform. The client 204 for the user can be one of a variety of clients as discussed above.

The source material for the geolocation analysis can include material associated with a user. For example source material obtained from social media, such as blogs and social networks. The source material can also include short codes and/or near field communications data or any other data associated with a user.

Web topologies like mesh networks can generate multipoint networks that provide Internet access to communications that are sentiment analytic, geolocational between humans, between humans and things, and between things. The systems of the present invention can be used in such networks.

(The discovery units discussed above can interact over electronic networks with (medical) devices that can sense, capture information, interact and communicate location and sentiment analysis of objects, humans, devices computing and non-computing devices.

The Mobile Web is a central network for engagement across all platforms. Mobile and social media can be important for sentiment analysis. The system of the present invention can also be used with the semantic web.

Predictive analytics and data mining can also be used to capture and generate sentiment and semantic analysis for conducting customized and personalized automated electronic commerce.

One embodiment of the present invention may be implemented using a conventional general purpose or a specialized digital computer or microprocessor(s) programmed according to the teachings of the present disclosure, as can be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, micro drive, and magneto-optical disks, ROMs, RAMs, EPROM's, EEPROM's, DRAM's, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

FIG. 3 illustrates a sample computing environment 300 which can be utilized in some embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304.

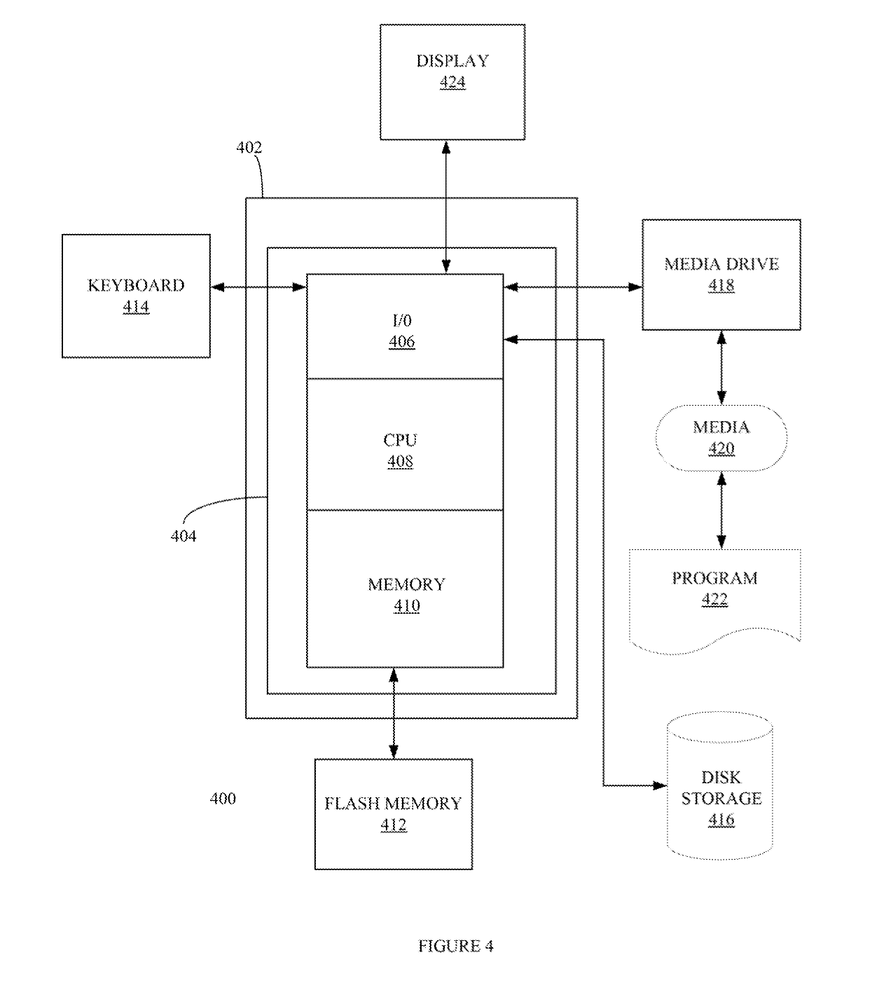

FIG. 4 depicts an exemplary computing system 400 that can be configured to perform any one of the above-described processes. In this context, computing system 400 may include, for example, a processor, memory, storage, and I/O devices (e.g., monitor, keyboard, disk drive. Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an I/O section 406, one or more central processing units (CPU) 408, and a memory section 410, which may have a flash memory card 412 related to it. The I/O section 406 is connected to a display 424, a keyboard 414, a disk storage unit 416, and a media drive unit 418. The media drive unit 418 can read/write a computer-readable medium 420, which can contain programs 422 and/or data.

### Example Processes

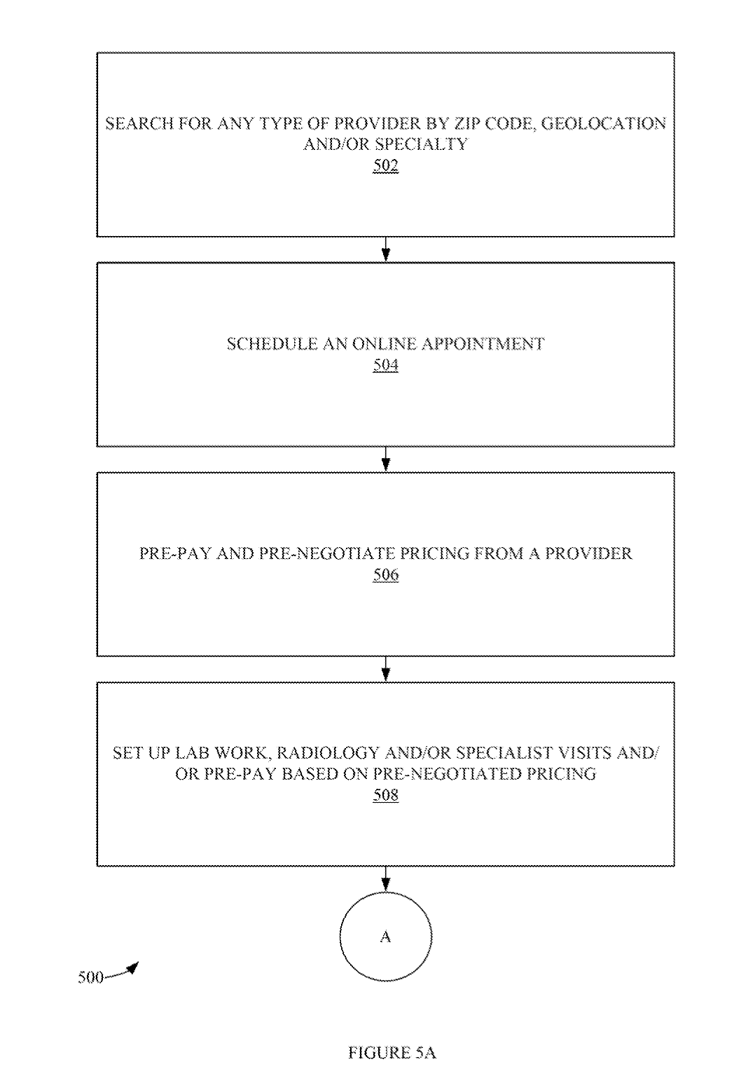

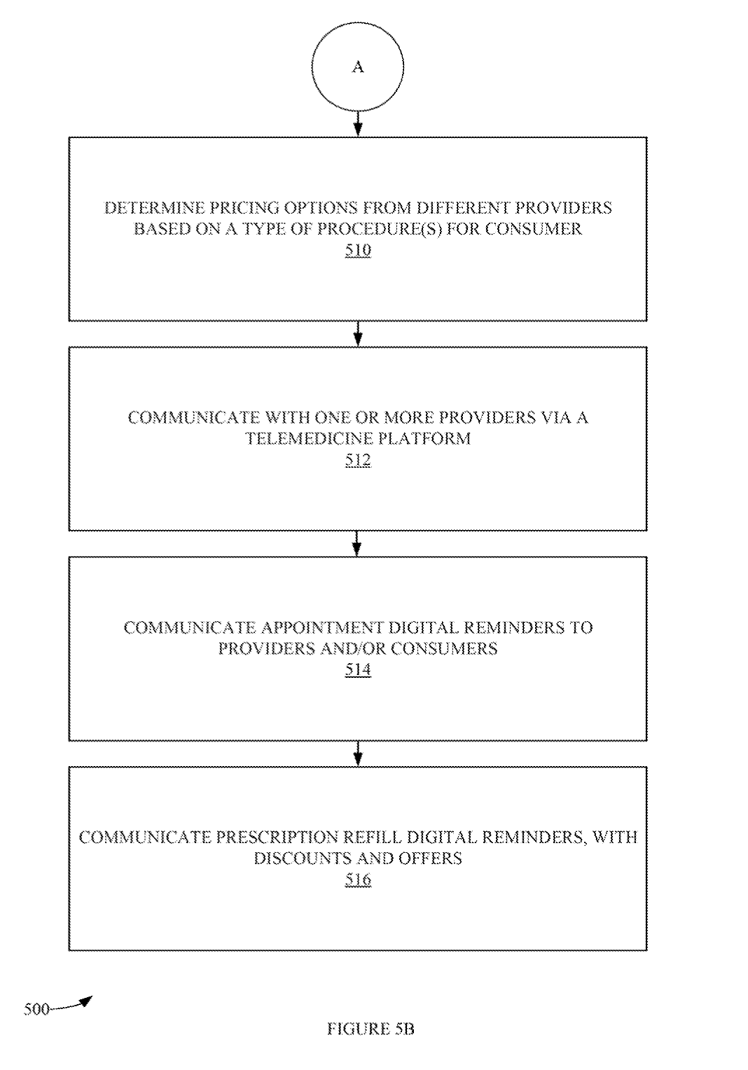

FIGS. 5 A-B illustrate an example process 500 of a telehealth services system, according to some embodiments. Process 500 can enable consumers to search, locate and communicate with health care providers over mobile and/or Internet communication platforms (e.g. e-mail, voice over Internet Protocol (VoIP), augmented-reality messaging, a videotelephony software application and the like), according to some embodiments. The telehealth services platform can include a database of health-care service providers, consumer profiles and/or health-care server information.

In step 502, a consumer can search for any type of telehealth service provider according to a set of telehealth service related categories such as zip code, geolocation and/or specialty of provider service (e.g. a medical doctor specialty type). For example, telehealth services system can maintain a web server to provide at least one web page. The telehealth services web page can include a search functionality that enables consumers to perform various search operations relating to step 502. The telehealth services web server can include one or more search engines that can search a database of telehealth services. It is noted that a consumer can upload any type of biometric screening/reading/test to the telehealth services system. For example, the consumer can upload blood sugar levels, blood pressure readings, chronic obstructive pulmonary disease (COPD) information, blood thickness/thinness readings (coagulations) and the like. These values can then be forwarded by the telehealth services system (e.g. via e-mail, text message, microblog post, etc.) to at least one primary care doctor. The telehealth services system can prioritize these messages. For example, telehealth services can include a functionality that reads the values as well as other information such as a user's health profile and determines that the particular reading's value warrants an alert that requires the consumer's primary-care physician's attention. In such an example, the telehealth services system can generate a special text message that can be indicated (e.g. both visually and/or aurally) that the incoming message requires the physician's attention. It is further noted that a consumer's particular historical and/or substantially current readings can be formatted as search terms to be utilized in step 502 of process 500.

In step 504, the consumer can schedule an appointment with a selected telehealth service provider. For example, the telehealth service web page can present a scheduling dashboard to the consumer that can be accessed via a web browser functionality in a client device 104 operated by the consumer. In step 506, the telehealth service can enable a consumer to pre-pay and/or pre-negotiate a price of the telehealth service with a selected telehealth service provider (e.g. via the telehealth service website, via short codes and/or via SMS messages with key words). In step 508, the telehealth service can also enable a consumer to set up various telehealth services (such as radiology treatments, specialists visits, etc.) based on pre-negotiated pricing. A consumer can also prepay for the telehealth service.

In step 510, the telehealth service system can enable a consumer to determine pricing options from different providers based on at least a type of procedure(s) for the consumer. In step 512, the telehealth service system can communicate to one or more relevant telehealth service providers via a telemedicine platform. In step 514, the telehealth service system can communicate digital reminders to providers and/or consumers. In step 516, the telehealth service system can communicate prescription refill reminders (e.g. with advertisements, coupons, discounts, offers, etc.) to a consumer's computing device.

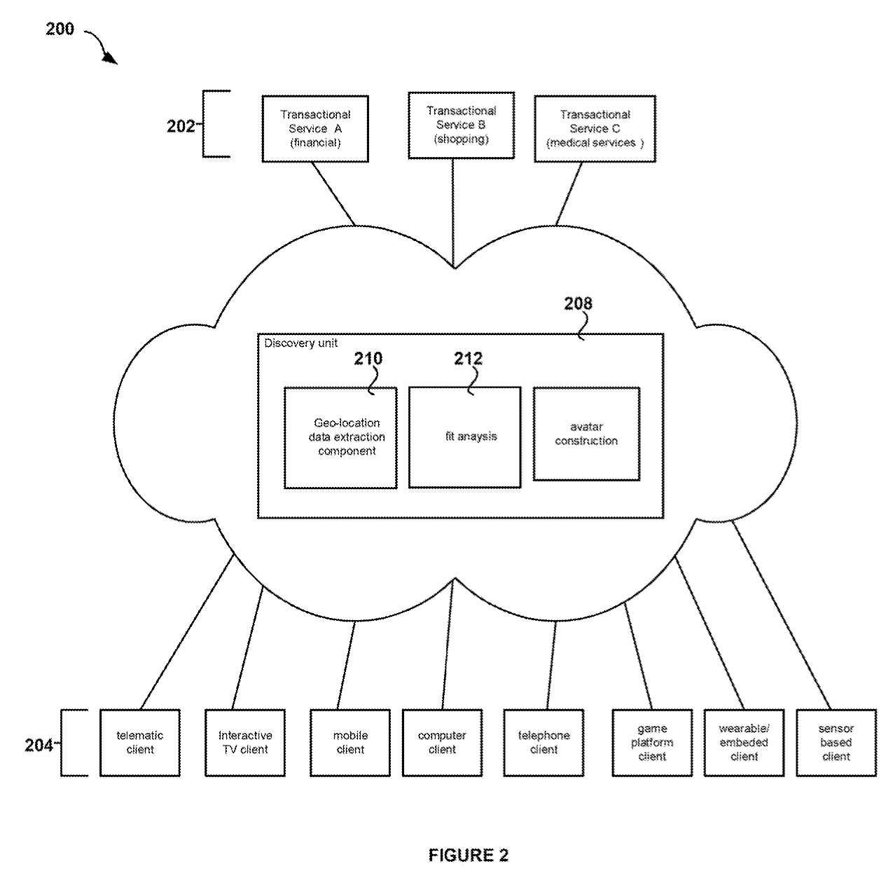

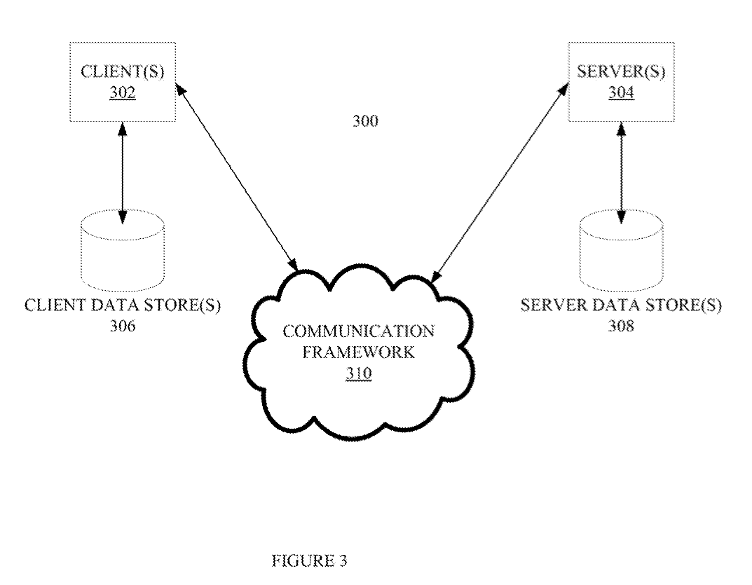

It is noted that the systems of FIGS. 1-4 can be modified to perform the various steps of process 500. In some examples, the telehealth service system can use varies digital communication methodologies such as text messages (e.g. SMS, MMS) and/or mobile device applications for real-time communication between a patient (e.g. the consumer) and the telehealth service provider (e.g. a physician).

### Example Use Cases

In one example, process 500 can be modified to include short code functionalities. For example, the telehealth service system can enable patients to find doctors, book appointments, pay for services and submit needs for surgery online, through mobile applications, through designated short codes. The telehealth service system can include a health care services video-network that an analytics platform can serve on-demand to consumers (e.g. with a video-sharing website managed by the telehealth service system). The videos can include educational health information. The telehealth service system can maintain and provide a automated mobile self-help system. The automated mobile self-help system can capture a consumer's personalized disease state and/or prescription history. In this way, this information can be viewed on the telehealth service system website and/or with a mobile application. This information can be integrated into a consumer's personal digital health record. Integrated laboratory results and other healthcare tests into our proprietary member portal through the web or mobile application that can be populated by predictive analytics. The telehealth service system can create a digital library of diseases and/or clinical applications that consumers can access on demand (e.g. using the search engine functionality provided for supra). The telehealth service system can maintain a national database of physicians (e.g. include various specialties/procedures, physician ratings, locations, experience levels, and the like). The telehealth service system can generate and maintain an automated-targeted mobile marketing advertisement based on targeted and/or personalized disease state, surgery requests, surgeries, conditions, actual prescriptions that can be used to build a predictive analytics and data mining platform. The telehealth service system can create a social media connection for members to share their experience with other potential members by leveraging big-data analytics to predict treatments and disease behaviors. Process 500 (an in some embodiments, the systems of FIGS. 1-4) can utilize machine-learning algorithms. Example machine-learning algorithms, such support vector machines (SVM), can include statistical classification analysis algorithms, statistical regression analysis algorithms, and the like. For example, discovery unit 124 can include an SVM module (not shown). SVM module can supervise learning models with associated learning algorithms that analyze data and recognize patterns, used for classification and regression analysis. The SVM module can take a set of input data and predict, for each given input, which of two possible classes forms the output, making it a non-probabilistic binary linear classifier. Given a set of training examples, each marked as belonging to one of two categories, the SVM module can build a model that assigns new examples into one category or the other. The SVM module can include a representation of the examples as points in space, mapped so that the examples of the separate categories are divided by a clear gap that is as wide as possible. New examples can then be mapped into that same space and predicted to belong to a category based on which side of the gap they fall on.

In another example, the system of FIGS. 1-4 can utilize a neuromemetic network to form a neuromemetic model (e.g. a neural and/or cognitive computing model). This computing model can be implemented in a cloud-computing accessible database. It can characterize social media inputs, and directory resources from users (e.g. requests and interaction information). The neuromemetic model can imitate biological and/or neurological functionality regarding fitness, priorities of attention, effectiveness and/or demand logic measured by frequency of request. As the system grows in use, in usage, with larger databases, user experiences, vendor services, the system can establish and/or adapts as an expert system of emergent rules (e.g. by identifying patterns that arise out of a multiplicity of interactions observed in the operation of the neuromemetic model). Emergent rules can govern metrics such as efficacy, priority, accuracy and value. The neuromemetic network can automatically capture conversations threads from mobile interactions (e.g. text, video, audio, voice, geolocation pin, etc.) and retain memories. For example, a process operating in discovery unit 124 can obtain and parse conversation thread content. These memories can be utilized to form new neuronal memories as a classification system, associated with certain transactions such as a search for information, diseases, medicine, treatments or doctors and other care providers. This system can utilize software and/or hardware (e.g. neuromemetic processors, neuromorphic integrated circuits, and the like) and/or a hybrid technique to simulate neuron models in a biological system (e.g. silicon neurons can be based on a Hodgkin-Huxley formalism and optimized for reproducing a large variety of neuron behaviors utilizing tunable parameters). An example of neuromorphic computer hardware is the Neurogrid board built by the Brains in Silicon group at Stanford University. This example can integrate various neuromorphic computing and/or neuromorphic engineering techniques. As used herein, neuromorphic computing can include the use of very-large-scale integration (VLSI) systems containing electronic analog circuits to mimic neuro-biological architectures present in the nervous system. In recent times the term neuromorphic has been used to describe analog, digital, and mixed-mode analog/digital VLSI and software systems that implement models of neural systems (for perception, motor control, or sensory integration). As used herein, cloud-computing can include a variety of different computing concepts that involve a large number of computers that are connected through a real-time communication network (typically the Internet). Cloud computing can include various techniques for distributed computing over a network and the ability to run a program on many connected computers at the same time. This example can be applied to process 500. For example, automatic predictive analytics can be implemented over cloud computer networks to enable functionalities of discovery unit 124 to analyze patient's health issues and/or access information as well as access medical resources.

In yet another example, the systems of FIGS. 1-4 can include mobile software agents (not shown) (e.g. digitally engineered software personality (DEPS)). DEPS, software agents and network swarms of agents can search, find, negotiate and/or transact about medical services and/or medical information offered by providers, brokers, insurance companies, government agencies and care givers. For example, an electronic-work flow can be created to connect patients, doctors, clinics and/or health care professionals together. The electronic-work flow can enable more effective communications, collaboration and health care. Discover unit 124 can use predictive analytics software to search medical databases and to provide decision analysis of the health care professionals and clinics that provide the “best fit” for patients who are searching for health care for specific illnesses. Connection over mobile electronic mobile networks can be implemented where patients and health care providers can interact, collaborate, transact and set up appointments for care using telehealth, video enabled communications over the mobile network or Internet. A directory information and assistance service for connecting individuals (e.g. clients, consumers, professionals such as attorneys, physicians, etc.) can be generated and managed by the discovery unit 124. The directory assistance service can maintain a mobile teleservices business that provides information (e.g. contact information, practice information, demographic information, etc.) and markets various services. A national data warehouse (e.g. that includes an analytics platform) can be generated and maintained by the discovery unit 124. The national data warehouse can examine patterns about the use of consumers of legal, medical and other services to market to third-party enterprises. In some embodiments, DEPS can be utilized to implement the avatars provided supra. For example, an avatar can be utilized to contact a user and mediate a response from the system to the user.

In one example, the systems provided herein can optimize the accuracy rate between a prospective buyer and seller of products and services using an integrative system of sentiment analysis, computational biology and mobile web services. Sentiment analysis can be captured by mining and analyzing semantics, to determine likes, dislikes, desire and objectives. The system(s) can use various linguistic, neuroscience, geo-location and computational biological resources to develop sentiment value scores that rank the solutions and or fit with the individuals search. The compositional sentiment and the contextual sentiment can be part of the sentiment values score that determines the buyers' fit with the automated presentation of the results. Interaction with the system (by the user and/or buyer) can refine the accuracy fit of the information and enhances meaning and utilitarian value. The acceptance of the presented information can one objective where sentiment mining results in a buyer selection of a product and/or service.

### Example Embodiment

A mobile knowledge management system can be provided (MKM). The MKM system can be designed to predict, communicate, transact, connect and access personalized and/or relevant information that matches buyers to professional vendors (e.g. doctors, health professionals, lawyers) of various services, over mobile networks or electronic networks, such as the Internet and/cellular networks. The MKM system can utilize analytics, cloud computing, agents and ‘big data’ management to enable implementation. The MKM system can be an automated system that, inter alia: analyzes service use patterns, builds a database of service behavior, and/or optimizes matching criteria between its internal data resources with external vendor and consumer interactions.

MKM system can be designed to simplify the accuracy and effectiveness of service offerings, especially in professional services such as health care, where there is a demand for more accurate and simplified access demand for care and health care information. The MKM system ue use the rising consumer adoption of the mobile platform as a popular and widespread delivery channel to deliver services.

The MKM system can handles various inputs (e.g. geographic, geospatial, geo-intelligent, geo-data, social media, frequency of service use, demand, condition, service request, semantic, service type, semantic and search frequency) over a mobile or electronic network (e.g. Internet) that include the input stream. The MKM system can estimates the probability of new values that fit the specific consumer and/or vendor interactions requested and/or fulfilled over mobile inputs. The MKM system can automatically correlate and/or extrapolate based on service use, what the probabilities and patterns of probabilities are that can produce effective transaction results. This analysis can be conducted in cloud computing networks via wireless networks.

The actual predictive values selection process can include an underlying model that can be extended and/or scaled (e.g. 100 exabyte plus of memory) to predict multiple value scenarios. Value scenarios can include consumer use cases collected by the MKM system to determine system effectiveness and/or to learn about the metrics of service effectiveness. The modeling of these Value Scenarios, are constantly being updated by consumer usage and vendor input and analyzed by the MKM system to optimize system performance. This is one of the internal inputs inside the MKM system that influences service optimization and knowledge management.

The MKM system analyzes various values via a prediction algorithm. The prediction algorithm can extract more precise meanings of certain search requests and thus connect buyers with sellers using a texting and proprietary short code mobile platform that is interoperable with the MKM cloud computing databases of service providers.

Predictive forecasts can be a function and/or output of the MKM system. Predictive forecasts can be triggered when prospective consumers of services use a mobile proprietary short code texting service (e.g. My 800 Doctor; *69 doctor) to search for, access specific vendor information, schedule an appointment, transact, purchase or communicate with professionals via the MKM system.

Predictive Forecasts can match up consumer requests via the MKM system with professional vendors, service providers, via accessing automatically in real-time, the cloud computing electronic directories and/or databases integrated into the MKM system's ‘back end’ information technology infrastructure and correlating that with the geographic and consumer search request.

The predicative analytics can include predictive forecasting. Predictive forecasting can automatically optimize the knowledge management outputs, providing outputs of service recommendations to consumers, collecting use case information and providing pattern recognition of service features such as treatment correlation, service types, social media interactions, consumer buying frequency, effective and ineffective service data, effective or popular service providers. Predictive forecasts can be implemented over mobile networks with an unlimited access to data storage and network connectivity to provide scalable inputs and data information relevant to consumers to be able to communicate, search, interact and transact with vendors and one another. Predicative forecasts analytics can be transacted and/or emerge from the interaction of internal information, inputs collected from vendors, system administrators and consumers that's been collected by, and resides inside the MKM system. This is then be used to optimize the efficiencies of knowledge management in the implementation of the MKM system.

Predictive forecasts can implement matching based on location by service provider and/or consumer. In some examples, matching based on location can use more complex information exchanges between service provider, consumer and/or the MKM system. These may include certain important, relevant or priority prediction values that influence the predictive forecast such as price, location, and type of service, specialty, availability, urgency of need, etc. The predictive forecast can also include the semantic analysis methods for matching predictive values a best fit between vendor and consumer. This personalized matching, can include the most accurate predictive values fit, such that the MKM system can act as a collaboration engine automatically and in real-time to connect consumers over the MKM system to vendors that comprise the best predictive values fit. This process can be automatically iterated by the MKM system until a match is found. At that point, a fixed prediction can be determined and communicated. In this way, the MKM system can be predictive, self-reflective and/or self-learning. The machine-learning capabilities of the MKM system can provide useful services for consumers.

The MKM System can automatically categorize various medical diagnoses and correlate them with genomic, epigenetic, physiological, cardiovascular and/or epidemiological information about a medical patient or a number of patients in a database. The MKM system can include a heuristic tool for assisting physicians determine disease states, prevention strategies, prediction and/or treatment modalities. To act as a decision analysis program to assist in more accurate medical diagnosis. Another example can include improved prediction and/or management of various risk factors. Accordingly, safer and more effective care for patient populations and individual care can be provided.

In another example, buyers can be connected with vendors who offer relevant services. The MKM system can provide faster and/or more accurate mobile connectivity between consumers and vendors.

DEPS and/or other agent based typology can be implemented by the MKM system. The use of an agent-based typology, such DEPS, can be used to collect analysis, communicate the analysis, search query, or access similar data to both the MKM system administrators and/or the consumers or service providers, external to the market but connected via the MKM system in commercial usage. The DEPS can communicate via video, text, voice networks with consumers and/or vendors as a collaboration facilitator, to communicate the match up of buyer and seller, this is an automated software application of the MKM system.

The DEPS can be a user interface that can communicate, transact, search and/or interact with humans, data, systems and networks. DEPS can interact via computer and/or human languages. DEPS are personalities that enable the output of the MKM system to have a personal user interface (e.g. DEPS may appear in a human like or surreal form via software design graphics) that can communicate and transact information that may appear human-like and can be customized by the user (e.g. vendor such as a health professional or consumer) to assist in decision analysis, search, transaction, communications while using the MKM system.

DEPS can assist disabled, elderly and/or ill patients to perform various tasks such as medicine consumption, setting an appointment, obtaining for medical assistant in an emergency, contacting a health professional, interacting with a patient, doctor and/or hospital administrator, accessing information, sensing and analyzing treatment effectiveness, communicating wireless information about a patient to a physician and/or MKM system.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it may be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A system comprising:
a number of transactional services;
a client which is one of a telematic client, an interactive TV-based client, a mobile client, a computer-based client, a telephone client, a game platform client, a sensor-based client, and a wearable/embedded client; and
a discovery unit receiving input from the client, the discovery unit determines a sentiment-based fit of one or more of the transaction services for a user at the client, the discovery unit using one or more of geospatial location, geospatial information, geo-mapping, data analysis, predictive analysis, near field communications data, interactive voice response analysis, short code data analysis and neuro-marketing information to make the sentiment-based fit.

2. The system of claim 1, wherein the discovery unit uses an avatar, and wherein the avatar comprises a digitally engineered software personality.

3. The system of claim 2, wherein the avatar is a personal avatar.

4. The system of claim 1, wherein the discovery software uses at least two of geospatial location, geospatial information, geo-mapping, data analysis, predictive analysis, near field communications data, interactive voice response analysis, short code data analysis and neuro-marketing information to make the sentiment-based fit.

5. The system of claim 1, wherein the discovery unit uses at least three geospatial locations; geospatial information, geomapping, data analysis, predictive analysis, near field communications data, interactive voice response analysis, short code data analysis and neuro-marketing information to make the sentiment-based fit.

6. The system of claim 1, wherein the discovery unit uses a neuromemetic network managed by the discovery unit to form a neuromemetic model.

7. The system of claim 6, wherein the discovery unit automatically captures a conversation thread from an interaction between two or more mobile devices.

8. The system of claim 7, wherein the neuromemetic model is implemented with at least one neuromorphic integrated circuit.

9. A method of a telehealth services system comprising:
providing a healthcare providers database, wherein the healthcare providers database comprises an healthcare provider schedule information, a healthcare provider specialty information, a healthcare provider pricing information;
providing a search engine, wherein the search engine is configured to search the database of healthcare providers based on at least one keyword;
providing a scheduling module configured to schedule an appointment between a consumer and a healthcare provider; and
providing a negotiation module to mediate a price negotiation between the consumer and the healthcare provider.

10. The method of claim 9, wherein the keyword is derived from a biosensor value based on a computer-wearable biosensor reading of a user attribute.

11. The method of claim 10 further comprising:
electronically communicating an appointment reminder to the consumer and the healthcare provider.

12. The method of claim 11, wherein an electronic communication comprises a text message communicated to a consumer's mobile device.

13. The method of claim 9, wherein the database comprises a prescription history of the consumer.

14. The method of claim 13 further comprising:
electronically communicating a prescription refill reminder to the consumer.

15. The method of claim 14, wherein the prescription refill reminder comprises a digital coupon for a medicine related to the prescription refill reminder.

16. The method of claim 9, wherein a personal avatar provides an interface with the search engine, the scheduling module and the negotiation module, and wherein the personal avatar comprises a digitally engineered software personality.

17. A computerized telehealth-services system comprising:
a processor configured to execute instructions;
a memory containing instructions when executed on the processor, causes the processor to perform operations that:
provide a healthcare providers database, wherein the healthcare providers database comprises an healthcare provider schedule information, a healthcare provider specialty information, a healthcare provider pricing information;
provide a search engine, wherein the search engine is configured to search the database of healthcare providers based on at least one keyword;
provide a scheduling module configured to schedule an appointment between a consumer and a healthcare provider;
provide a negotiation module to mediate a price negotiation between the consumer and the healthcare provider; and
electronically communicating an appointment reminder to the consumer and the healthcare provider.

18. The computerized telehealth-services system of claim 17, wherein the database comprises a prescription history of the consumer, wherein a personal avatar provides an interface with the search engine, the scheduling module and the negotiation module, and wherein the personal avatar comprises a digitally engineered software personality.

19. The computerized telehealth-services system of claim 18, wherein memory containing instructions when executed on the processor, causes the processor to perform operations that:
electronically communicate a prescription refill reminder to the consumer.

20. The computerized telehealth-services system of claim 19, wherein the keyword is derived from a biosensor value based on a computer-wearable biosensor reading of a user attribute.
